(19) United States
(12) Patent Application Publication
(10) Pub. No.: US 2013/0106209 A1
(43) Pub. Date: May 2, 2013

(54) HANDHELD ELECTRIC TOOL

(71) Applicants: Jens Blum, Filderstadt (DE); Heiko Roehm, Stuttgart (DE); Tobias Herr, Stuttgart (DE)

(72) Inventors: Jens Blum, Filderstadt (DE); Heiko Roehm, Stuttgart (DE); Tobias Herr, Stuttgart (DE)

(21) Appl. No.: 13/638,450

(22) PCT Filed: Mar. 31, 2011
(86) PCT No.: PCT/EP11/55007

§ 371 Date: Dec. 14, 2012

(30) Foreign Application Priority Data
Apr. 1, 2010 (DE) 102010003583.1

(51) Int. Cl. H02K 11/00

(52) U.S. Cl. CPC H02K 11/0005
USPC 310/50

(57) ABSTRACT

A handheld electric tool has a tool housing in which a drive motor having an assigned commutator is situated, and a screening ring furnished with metal is provided in the area of the commutator on the tool housing for shielding electromagnetic radiation.

### BACKGROUND OF THE INVENTION

1. Field of the Invention

The present invention relates to a handheld electric tool having a tool housing in which a drive motor having an associated commutator is situated.

2. Description of the Related Art

Such handheld electric tools are known from the related art, in which a drive motor provided with a commutator is situated in an assigned tool housing, the commutator having a collector, which is in sliding contact on a collector running surface with assigned brushes, via which a required motor current is suppliable to the drive motor. During operation of these electric tools, the collector, mounted on a rotor which is driven by the drive motor, usually rotates in relation to the brushes which are fixedly mounted in the tool housing for commutation of the motor.

A disadvantage of this related art is that the commutator generates electromagnetic radiation, which is radiated away from the tool, in commutation changes during operation of the electric tool.

### BRIEF SUMMARY OF THE INVENTION

One object of the present invention is therefore to provide a novel handheld electric tool, in which at least a reduction in the electromagnetic radiation radiated by the electric tool during operation is at least made possible.

This problem is solved by a handheld electric tool having a tool housing, in which a drive motor having an assigned commutator is situated. A screening ring, furnished with metal, for screening electromagnetic radiation is provided on the tool housing in the area of the commutator.

The present invention thus allows the use of a simple and inexpensive screening ring for reducing the electromagnetic radiation which is generated in commutation changes of the commutator and is radiated by the electric tool.

According to one specific embodiment, the drive motor is situated in an assigned motor housing, which is mounted in the tool housing.

The present invention thus allows a secure and reliable reduction in the electromagnetic radiation radiated by the electric tool in the case of electric tools having a so-called “open frame” style as well as in the case of electric tools having a so-called “can” style.

Preferably no electrically conductive connection exists between the screening ring and the metallic components of the drive motor.

Thus the required screening effect of the screening ring may be easily ensured.

The screening ring is preferably situated on the tool housing in a sleeve shape.

A compact screening ring having comparatively little weight may thus be provided on the tool housing.

According to one specific embodiment, the commutator has a collector, which is in sliding contact on a collector running surface with assigned brushes. The collector running surface is sheathed by the screening ring, at least in sections.

The present invention thus makes it possible to provide an inexpensive screening ring having comparatively small dimensions.

Preferably at least the brushes are sheathed by the screening ring.

Secure and reliable screening of the brushes may thus be achieved.

According to one specific embodiment, the tool housing is made of plastic.

The present invention thus makes it possible to provide an inexpensive tool housing having comparatively little weight.

According to one specific embodiment, the screening ring features steel, copper, aluminum, iron, zinc and/or magnesium.

A compact screening ring, with which an efficient reduction in the radiated electromagnetic radiation may be achieved, may thus be made available.

The screening ring preferably has a square or circular cross section.

A simple and stable screening ring may thus be provided.

According to one specific embodiment the screening ring is designed in the form of a spiral spring or a mesh.

It is thus possible to provide a screening ring having comparatively little weight.

According to one specific embodiment, the screening ring is designed to permit at least a reduction in the electromagnetic radiation, which occurs in commutation changes of the commutator and is radiated during operation of the electric tool,

### BRIEF DESCRIPTION OF THE DRAWINGS

FIG. 1 shows a schematic view of a handheld electric tool according to a first specific embodiment.

FIG. 2 shows a schematic view of the electric tool from FIG. 1 according to a second specific embodiment.

### DETAILED DESCRIPTION OF THE INVENTION

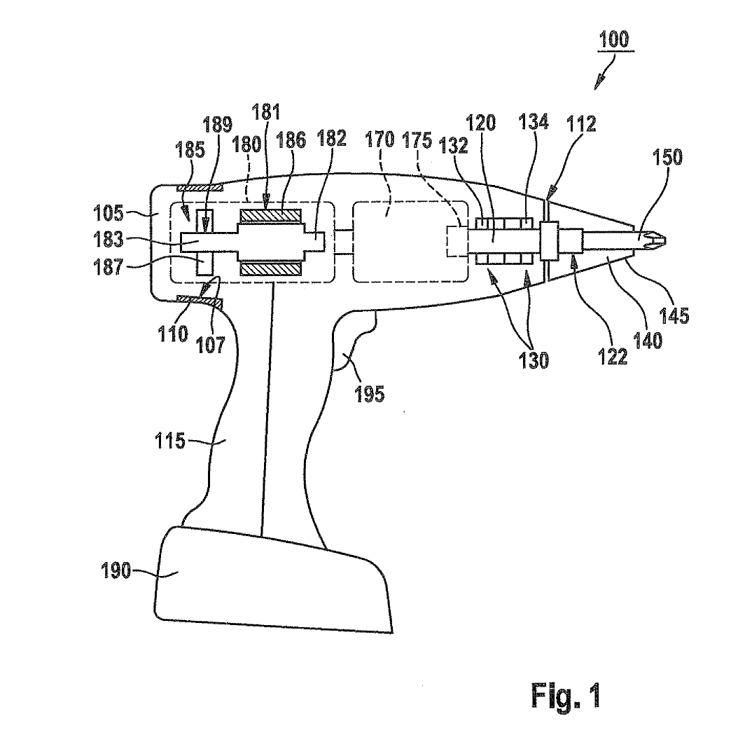

FIG. 1 shows a handheld electric tool 100 according to a first specific embodiment. For example, it has a tool housing 105 having a handle 115 and is mechanically and electrically connectable to a battery pack 190 for off-grid power supply. FIG. 1 shows electric tool 100 as a cordless combi drill, for example, but it is pointed out that the present invention is not limited to cordless combi drills but instead may also be applied to various electric tools, in particular cordless tools, in which rotation of the tool is induced, e.g., in the case of a cordless screwdriver, a cordless percussion drill, etc. Furthermore, the present invention may also be applied to electric tools, which are operated dependent on the power grid.

An electric drive motor 180 powered by battery pack 190 and a gear 170 are provided in tool housing 105, which, according to one specific embodiment, is made of plastic, e.g., PC, PA, ABS and/or PA/ABS, at least in sections. Drive motor 180 is connected to a drive shaft 120 via gear 170. Drive shaft 120 is rotatably mounted in tool housing 105 via a bearing arrangement 130 and is provided with a tool receptacle 140, which is situated in the area of an end face 112 of tool housing 105 and has a drill chuck 145, for example. Bearing arrangement 130 is mounted on tool housing 105 here, for example.

Tool receptacle 140 receives a tool 150 and may be integrally molded on drive shaft 120 or may be connected as an attachment to the drive shaft. For example, tool receptacle 140 is designed as an attachment in FIG. 1 and is mounted on mounting device 122, which is provided on drive shaft 120.

Bearing arrangement 130 has, for the purpose of illustration, a first bearing 134 and a second bearing 132 at a distance from the latter, the two bearings being designed as ball bearings, for example. However, it is pointed out that other types of bearings may also be used within the scope of the present invention. For example, bearings 132, 134 may alternatively be implemented as friction bearings, needle bushes, roller bearings or other types of anti-friction bearings.

According to one specific embodiment, drive motor 180 is designed in the so-called “open frame” style, in which tool housing 105 of electric tool 100 functions directly as the motor housing, i.e., assigned stator components and rotor components 181 and 182 of motor 180 may be supported or mounted directly on tool housing 105.

Gear 170 is a planetary gear, for example, having various gear stages or planetary stages to which an optional torque coupling 175 is assigned. Planetary gear 170 is rotationally driven by drive motor 180 during operation of electric tool 100. However, it is pointed out that the use of a planetary gear is mentioned here only as an example and should not be construed as restricting the present invention. Any suitable type of gear may in fact be used.

Drive motor 180, which is operable via a hand switch 195, is a d.c. motor, for example, having a commutator 185 for commutation and provided at least partially with metallic components 186, which are not shown further here for the sake of clarity and simplicity of the drawings in FIG. 1. Commutator 185 has a collector 183, which establishes a sliding contact on an assigned collector running surface 189 having two or more brushes 187, e.g., carbon brushes, so that a suitable motor current is supplied to motor 180 via brushes 187 and collector 185 during operation of electric tool 100. Drive motor 180 here may be controllable in such a way that a reversing mode as well as specifications with regard to a desired rotational speed may be implemented. The functioning and design of a suitable drive motor having an assigned commutator are sufficiently well known from the related art, so that a detailed description will not be given here for the purpose of brevity of the description.

According to one specific embodiment, a screening ring 110, furnished with metal and provided in the area of commutator 185, is mounted on tool housing 105 and is shown in a sectional view in FIG. 1 for the purpose of illustration. Screening ring 110 is preferably designed in the shape of a sleeve and, for the purpose of illustration, is situated in a circumferential groove 107, which is formed on tool housing 105 or is secured therein, e.g., by injection.

Screening ring 110 is designed for screening electromagnetic radiation which occurs on commutator 185 during operation of electric tool 100 in commutation changes and is radiated from electric tool 100. For this purpose, screening ring 110 surrounds collector running surface 189 of commutator 185, at least in sections, and preferably sheaths at least brushes 187. Preferably no electrically conductive connection exists between screening ring 110 and metallic components 186 of drive motor 180, so as not to impair the screening effect of screening ring 110.

According to one specific embodiment, screening ring 110 has a square or circular cross section and features steel, copper, aluminum, iron, zinc and/or magnesium. Screening ring 110 may thus be designed as a film and/or wire, for example. Furthermore, screening ring 110 may be designed in the shape of a sleeve and/or as a spiral spring and/or a mesh, at least in sections.

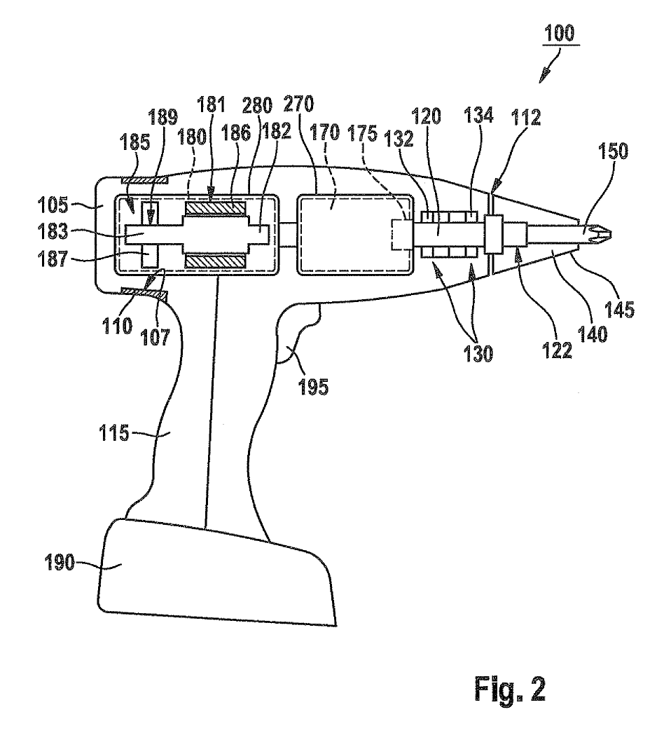

FIG. 2 shows the handheld electric tool 100 from FIG. 1 according to a second specific embodiment, in which drive motor 180 has the so-called “can” style in contrast with FIG. 1. Accordingly, at least drive motor 180 is situated in an assigned motor housing 280. Motor housing 280 is situated and mounted in tool housing 105 of electric tool 100.

Gear 170 also has an assigned gear housing 270 for the purpose of illustration. Furthermore, commutator 185 is also situated at least partially in motor housing 280.

1-11. (canceled)

12. A handheld electric tool, comprising:
a tool housing;
a drive motor having an assigned commutator, wherein the drive motor is situated in the tool housing; and
a screening ring furnished with metal, wherein the screening ring is provided in the area of the commutator on the tool housing for screening electromagnetic radiation.

13. The electric tool as recited in claim 12, wherein the drive motor is situated in an assigned motor housing which is mounted in the tool housing.

14. The electric tool as recited in claim 12, wherein no electrically conducting connection exists between the screening ring and metallic components of the drive motor.

15. The electric tool as recited in claim 14, wherein the screening ring is situated in a sleeve shape on the tool housing.

16. The electric tool as recited in claim 14, wherein the commutator has a collector, and wherein the collector has a collector sliding surface which is in sliding contact with assigned brushes, and wherein the collector sliding surface is sheathed by the screening ring at least in sections.

17. The electric tool as recited in claim 16, wherein the brushes are sheathed by the screening ring.

18. The electric tool as recited in claim 16, wherein the tool housing is made of plastic.

19. The electric tool as recited in claim 16, wherein the screening ring includes at least one of steel, copper, aluminum, iron, zinc and magnesium.

20. The electric tool as recited in claim 16, wherein the screening ring has one of a square cross-section or a circular cross-section.

21. The electric tool as recited in claim 16, wherein the screening ring is configured in the form of one of a spiral spring or a mesh.

22. The electric tool as recited in claim 16, wherein the screening ring is configured to at least reduce electromagnetic radiation which occurs in commutation changes of the commutator and radiated during operation of the electric tool.
